(19) United States
(12) Patent Application Publication
(10) Pub. No.: US 2017/0050888 A1
(43) Pub. Date: Feb. 23, 2017

(54) Production of Ceramic Metal Oxide Membranes by Means of Reactive Electrospinning

(71) Applicant: Cal Poly Pomona Foundation Inc., Pomona, CA (US)

(72) Inventors: Keith M. Forward, South Pasadena, CA (US); Victoria R. Medinilla, Pomona, CA (US); Cynthia V. Jimenez, Fallbrook, CA (US); Fransisca Oei, Anaheim, CA (US); Susana Vargas, Fullerton, CA (US)

(73) Assignee: Cal Poly Pomona Foundation Inc., Pomona, CA (US)

(21) Appl. No.: 15/233,781

(22) Filed: Aug. 10, 2016

Related U.S. Application Data
(60) Provisional application No. 62/207,219, filed on Aug. 19, 2015.

(51) Int. Cl. C04B 35/624; D01D 5/00; D01F 8/18; H01G 9/20; D01F 8/10; B29C 47/00; C04B 35/622; B01D 53/04; D01F 8/04

(52) U.S. Cl. CPC C04B 35/624; B01D 53/04; D01D 5/0046; D01F 8/18; D01F 8/04; D01F 8/10; B29C 47/0004; B29C 47/0076; C04B 35/62259; H01G 9/2027; B01D 2253/1124; B01D 2257/504; D10B 2101/08; D10B 2321/08; D10B 2321/12; D10B 2331/06; D10B 2505/00; B29L 2031/34

(57) ABSTRACT

Traditionally, the manufacturing of ceramic metal oxide membranes is often expensive and extremely labor intensive due to the often necessary post-processing steps. The present invention discloses to a novel single-step process, to produce ceramic metal oxide membranes. More specifically, this invention relates to reactive electrospinning where a sol-gel solution containing alkoxides is electrically charged and formed a Taylor cone at the tip of a needle in an environment controlled chamber, and the Taylor cone rejects a continuous stream of alkoxide nanofibers which polymerized to form a ceramic metal oxide membrane (with and without a polymer substrate present). The manufactured membranes may be used for various applications, including dye sensitized solar cells and for carbon dioxide capturing.

### RELATED APPLICATION

This application claims the benefit of priority under 35 USC. §119(e) to Provisional Application No. 62/207,219, filed on Aug. 19, 2015, which is incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### THE NAMES OF THE PARTIES TO A JOINT RESEARCH AGREEMENT

Not applicable.

### BACKGROUND OF THE INVENTION

Experts agree that carbon dioxide is the leading cause of the increase in global temperature. In 2014, the Earth experienced a level of 397.7 ppm of CO₂, an increase of 1.9 ppm from 2013. According to the United Nations Environmental Programme (UNEP), the Earth is expected to experience a rise in temperature of over 4° Celsius if trends continue. Global warming presents several drastic consequences for mankind and the planet. Climate change is linked to rising sea levels and ocean acidification. Ocean acidification is caused by the reaction of water and carbon dioxide to form carbonic acid. Carbonic acid reacts with bicarbonate ions, ions critical to the formation of marine invertebrate Shells. Rising ocean acidity has been linked to the decline of marine invertebrate populations, a base food source for larger creatures such as salmon and whales. Rising sea levels threaten millions people. In addition, rising sea levels threaten states such as the Netherlands and Vietnam, countries that will see 47% and 26% of their populations affected, respectively. Medically, rises in the Earth's temperature are linked to a host of problems. Heat waves, caused by shifts in weather patterns, result in increased mortality rates from heat stroke and cardiovascular problems. Increased temperatures also provide more habitable environments for mosquitoes and consequently, mosquito-borne illnesses such as dengue and malaria.

To reduce the amount of carbon dioxide and other malignant gases in the atmosphere, Carbon Capture and Storage (CCS) technology has been developed and implemented industry-wide given to the large contribution of greenhouse gases noted from the industrial arena. CCS is the process of removing carbon dioxide from a stream, which can be done primarily in three ways: absorption, adsorption, and cryogenic distillation. Of all methods, adsorption through solid membranes is considered a feasible pathway for the future of CCS. Adsorption involves the use of sorbent membranes that capture carbon dioxide particles as gas is passed through the membranes. Upon applying either temperature or pressure change, the carbon dioxide can be released into a container to prevent its release into the atmosphere. Sorbent membranes offer potential savings over other methods because they do not need a solvent and therefore require less energy to regenerate, as the energy applied is not going towards heating the solvent, as in absorption methods. Adsorption membranes should be resistant to high temperatures and deterioration. Moreover, membranes should have high microscopic surface area to allow for maximum sorbent interaction. Ceramic metal oxide membranes (e.g., magnesium oxide membranes) are considered viable candidates for adsorption processes because they exhibit high surface area, low density, high porosity and resistance to high temperature and corrosion.

In addition to being used in CCS, metal oxide membranes (comprising metal oxides nanofibers) with high specific surface area, porosity and individual size particles may be used as bactericides, adsorbents and catalysts for specific Chemical reactions, including energy transformation reactions such as those found in solar cells. An example of such metal oxide is magnesium oxide which may be produced into nanofibers.

The present invention relates to a novel process of manufacturing ceramic metal oxide membranes via reactive electrospinning. Metal oxide ceramic membranes are employed in a broad range of applications. These metal oxide membranes can be found in catalyst systems, microbiological analysis, filtration applications, energy storage devices, and many other areas. However, the manufacturing of these membranes is often expensive and extremely labor intensive due to the often necessary post-processing steps. This invention relates to a novel, single-step process, to produce these highly desirable ceramic metal oxide membranes. More specifically, this invention relates to reactive electrospinning where a sol-gel solution containing metal alkoxides transports into an electro-hydrodynamic jet and promotes the hydrolysis of the metal alkoxides to form a ceramic metal oxide membrane (with and without a polymer substrate present). The produced membranes may be used for various applications.

### BRIEF SUMMARY OF THE INVENTION

Traditionally, the manufacturing of ceramic metal Oxide membranes is often expensive and extremely labor intensive due to the often necessary post-processing steps. The present invention discloses to a novel single-step process to produce ceramic metal oxide membranes. More specifically, this invention relates to utilizing reactive electrospinning where a sol-gel solution containing metal alkoxides transports into an electro-hydrodynamic jet and promotes the hydrolysis of the metal alkoxides to form a ceramic metal oxide membrane (with and without a polymer substrate present). The manufactured membranes may be used for various applications, including dye sensitized solar cells and for carbon dioxide capturing.

It is an objective of this invention to provide a single-step process for producing ceramic metal oxide membranes.

It is a further objective of this invention to provide a method of electrospinning without the need of a polymer substrate.

It is a further objective of this invention to provide a method of inducing chemical reaction inside an electrohydrodynamic jet.

These and other objectives are preferably accomplished by providing a single-step process to produce ceramic metal oxide membranes by utilizing reactive electrospinning where a sol-gel solution containing metal alkoxides is electrically charged and formed a Taylor cone at the tip of a needle in an environment controlled chamber, and the Taylor cone rejects a continuous stream of the metal alkoxide nanofibers which condensed and polymerized to form a ceramic metal oxide membrane.

These and other aspects of this invention will become apparent to those skilled in the art after reviewing the following description of the invention.

### BRIEF DESCRIPTION OF THE DRAWING

The above-mentioned features and objects of the present disclosure will become more apparent with reference to the following description taken in conjunction with the accompanying drawings and images wherein .like reference numerals denote like elements and in which:

FIG. 1 is a schematic of one embodiment of the reactive electrospinning process for manufacturing ceramic metal oxide membranes.

### DETAILED DESCRIPTION OF THE INVENTION

For illustrative purpose, the principles of the present invention are described by referring to an exemplary embodiment thereof. Before any embodiment of the invention is explained in detail, it should be understood that the invention is not limited in its application to the details of construction and the arrangement of components set forth in the following description or illustrated in the following drawings. The invention is capable of other embodiments and of being practiced or of being carried out in various ways. Also, it should be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention discloses a process of metal oxide (e.g., magnesium oxide) membranes exhibiting a ceramic quality such as a visible and consistent rigidity. Magnesium oxide (MgO), for example, boasts a high melting point, a low density, and a high modulus of rupture; and is a candidate for efficient carbon dioxide (CO₂) capturing. For the application of the CCS technology, it is desirable that the MgO nanofiber membranes have a high surface area to mass ratio, and are porous enough to promote the entrapment of gaseous CO₂ molecules. In order to produce nanofiber membranes of this nature, a chemical process involving the polymerization of an MgO network is suggested. The process begins with a magnesium alkoxide, which may be prepared by creating a solution containing magnesium methoxide and a polymer in an organic solvent (a sol-gel solution). This magnesium alkoxide then undergoes a two-step hydrolysis reaction to produce magnesium hydroxide:

Mg(OCH₃)₂+H₂O->Mg(OH)(OCH₃)+CH₃OH

Mg(OH)(OCH₃)+H₂O->Mg(OH)₂+CH₃OH

However, this reaction will not go to completion, resulting in only a partial hydrolysis of the magnesium alkoxide. Due to this partial hydrolyzation, two polymerization reactions will occur next to facilitate the formation of the oxide polymer:

Mg-OCH₃+HO-Mg-->-Mg-O-Mg-+CH₃OH

Mg-OH+HO-Mg-->-Mg-->-Mg-O-Mg-+H₂O

The “-” to the sides of the Mg indicates that the Mgs are not met with any bonded atoms and represents a large, ongoing structure being produced. The polymer facilitates and catalyzes the polymerization of MgO, thereby creates a chemical network. This is also referred to as a “sol-gel process.”

The sol-gel process essentially comprises three steps: partial hydrolysis, condensation, and polymerization. A metal alkoxide undergoes partial hydrolysis by mixing a solvent, catalyst, and water with the metal alkoxide to form a reactive monomer. Further hydrolysis promotes the formation of colloids through polymerization and cross-linking, which in turn creates a sol-gel. The sol-gel can then be turned into either aerogel or xerogel based on the drying method. Xerogels are formed by evaporation of the solvent which causes the gel to shrink. The time required to evaporate the solvent can be reduced by placing the gel in a well-ventilated environment. Xerogels are desirable in the case of metal oxide membranes for CCS due to their larger pore size, surface area, high absorption capacity, and with less than 10% of the volume of the original gel.

Utilizing the chemical process discussed above, reactive electrospinning simultaneously initiates the reaction and electrospins to form the nanofibrous material (e.g., nanofibrous membranes). This is achieved by electrospinning a sol-gel solution containing metal alkoxide in a controlled, humid environment, where the sol-gel solution jetting at the tip of a needle is exposed to the moisture in the air, driving the hydrolysis, condensation, and polymerization reactions mentioned above. In essence, the present invention simplifies and condenses the manufacturing process while maintaining the synthesis of useful, metal oxide nanofibers.

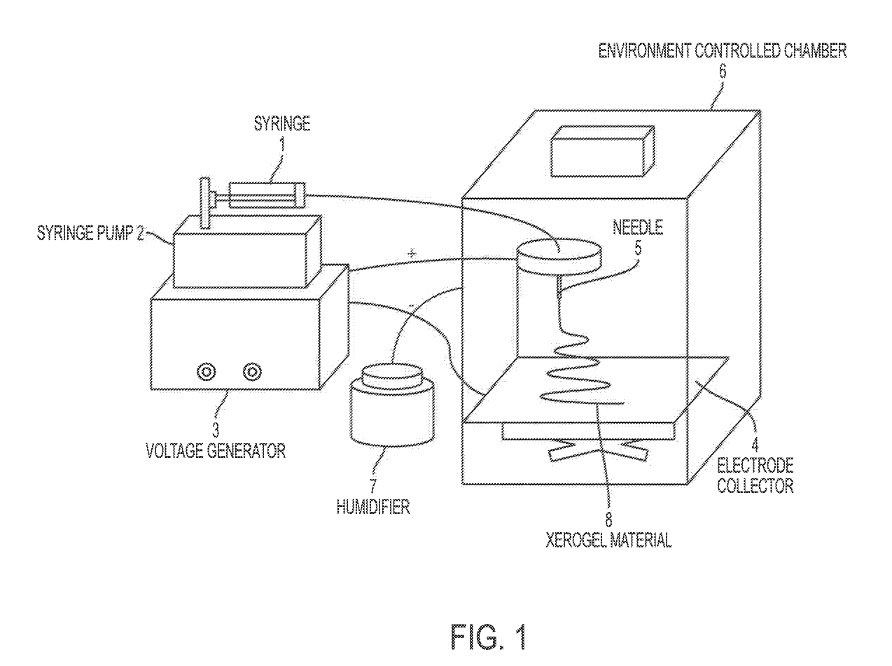

FIG. 1 describes one embodiment of the reactive electrospinning process for manufacturing ceramic metal oxide membranes. A sol-gel solution is placed in a syringe 1 which is connected to a syringe pump 2 for jetting the sol-gel solution through the needle 5. The sol-gel solution comprises a solvent, at least one metal alkoxide, and at least one polymer to facilitate polymerization. The polymer, once electrospun, provides the structural support for the metal oxide particles.

In one embodiment, the polyethylene oxide polymer (PEO) is used. PEO does not require curing and has molecular weights ranging from 100,000 to 8,000,000. The PEO provides film formation, water retention, binding, lubricity, and thickening benefits. Along with these benefits, PEO is also beneficial due to its solubility in water, ethanol, toluene, acetone, chloroform, methylene, and chloride. In one embodiment, a small portion of dichloromethane is added to the sol-gel solution, in order to aid the solubility of PEO. The metal alkoxide may include magnesium alkoxide and/or titanium alkoxide. In one embodiment, the sol-gel solution comprises 4 MDa polyethylene oxide, acetic acid, magnesium methoxide, methanol and dichloromethane. In another embodiment, the sol-gel solution comprises 4 MDa polyacrylic acid, acetic acid, magnesium methoxide, and methanol.

In another embodiment, the sol-gel solution comprises an alkoxide precursor in a non-aqueous solvent. This precursor may be but limited to the follow precursor: Magnesium methoxide, titanium isopropoxide and tetraethyl orthosilicate. A polymer such as polyvinylpyrrolidinone and/or polyethylene oxide to the solution may be added to improve mechanical properties of metal oxide membranes.

Referring to FIG. 1, a voltage generator 3 is connected to the needle 5 and an electrode collector 4 that collects product nanofibers. The electrospinning process occurs in an environment controlled chamber 6, e.g., controlled pressure, temperature, and/or humidity. In one embodiment, a humidifier 7 may be used to maintain the humidity in a desired level. When the voltage generator 3 applies a voltage (e.g., 5-20 kV) to the sol-gel solution, a small electro-hydrodynamic jet is formed while in a humidity-controlled environment. The electro-hydrodynamic jet exhibits a high surface area to volume ratio which increases the reaction rate when the water from the surrounding air initiates the partial hydrolysis. While the jetting sol-gel solution travels towards the electrode collector 4, the solvent evaporates arid colloids are formed via a condensation reaction, which leads to the polymerization of the metal oxide to produce the xerogel material 8, i.e., ceramic metal oxide membranes. The diameter of the polymer fibers produced can range from 0.1 micrometers to 10 micrometers. It is possible to obtain a different morphology of the ceramic membrane by altering the solution properties such as the conductivity of the solution, distance between the needle 5 and the electrode collector 4, voltage, time and flow rate of electrospinning, polymer molecular weight and concentration.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

1. A method for manufacturing ceramic metal oxide membranes by electrospinning comprising:
applying an electric voltage to a sol-gel solution wherein the sol-gel solution comprising a solvent, at least one metal alkoxide, and at least one polymer;
jetting the sol-gel solution an electrode collector in a controlled environment with a pre-determined humidity, wherein the metal alkoxide hydrolyzed into a metal oxide, the solvent vaporizes, and a condensation reaction occurs that results in the polymerization of the metal oxide.

2. The method for manufacturing ceramic metal oxide membranes of claim 1 wherein the electric voltage is between 5 to 20 kV.

3. The method for manufacturing ceramic metal oxide membranes of claim 1 wherein the at least one polymer is selected from 4 MDa polyethylene oxide, polyvinylpyrrolidinone, and 4 MDa polyacrylic acid.

4. The method for manufacturing ceramic metal oxide membranes of claim 1 wherein the at least one metal alkoxide comprising an alkoxide precursor in a non-aqueous solvent wherein the alkoxide precursor is selected from magnesium methoxide, titanium isopropoxide and tetraethyl orthosilicate.

5. The method for manufacturing ceramic metal oxide membranes of claim 1 wherein the sol-gel solution further comprising acetic acid.
